(19) United States
(12) Patent Application Publication
(10) Pub. No.: US 2015/0025918 A1
(43) Pub. Date: Jan. 22, 2015

(54) FORECASTING AND MANAGEMENT SYSTEM AND METHOD CONCERNING TICKET TRANSACTIONS IN MULTIPLE MARKETS

(71) Applicant: Broker Genius LLC, Far Rockaway, NY (US)

(72) Inventor: Shmuel Sherman, Far Rockaway, NY (US)

(21) Appl. No.: 14/328,457

(22) Filed: Jul. 10, 2014

Related U.S. Application Data
(60) Provisional application No. 61/847,003, filed on Jul. 16, 2013.

(51) Int. Cl. G06Q 10/02; G06Q 30/02

(52) U.S. Cl. CPC G06Q 10/02; G06Q 30/0206
USPC 705/5

(57) ABSTRACT

System and methods of managing ticket inventory multiple ticket exchanges receive a selection of listing data relating to a set of tickets in a user's ticket inventory; identify, based on the listing data and one or more predefined user preferences, a set of available ticket listings listed on a ticket exchange representing a relative market with which to compare the listing data; determine a current market price and a future market price for the relative market; assess whether the future market price exceeds the current market price; and set a listing price based on the assessing step. The listing price is set relative to a reference price when the future market price does not exceed the current market price. The reference price is monitored for changes; and the listing price is dynamically adjusted as required to remain priced relative to the reference price.

### CROSS-REFERENCE TO RELATED APPLICATIONS

This patent application claims the benefit of priority from U.S. Provisional Patent Application Ser. No. 61/847,003, filed on Jul. 16, 2013, entitled “Forecasting and Management System and Method Concerning Ticket Transactions in Multiple Markets,” which is hereby incorporated by reference as if set forth in its entirety herein.

### FIELD OF THE INVENTION

The present invention relates to a ticket management platform, and more particularly, to forecasting and management systems and methods concerning ticket transactions in multiple markets.

### BACKGROUND OF THE INVENTION

### Ticket Industry Background:

Tickets for events, such as sporting events and concerts, are typically sold first on a primary ticket market and often resold on a secondary ticket market. The primary market as described herein refers to the original ticket issuer(s)/seller(s) of a particular type of event ticket. For sports tickets, purchasing from the primary market means buying tickets to either a single game, a multi-game package, or season tickets, directly from the team. For concert and theatre tickets, purchasing tickets from the primary market means buying directly from the artist or through a concert promoter.

There are a number of primary ticket sellers, which together make up the primary ticket market. For example, Ticketmaster® is the industry leader for selling primary market tickets. It has technology in place which allows teams, artists, and promoters to have their tickets listed and marketed. In 2010, Ticketmaster® owned an estimated 70% primary market share of the concert market. It is also the primary ticket seller for 27 of the 30 National Hockey League (NHL) teams, 28 of 30 National Basketball Association (NBA) teams, and all 32 National Football League (NFL) teams. Additional example primary market outlets include AEG (AXS.com), Tickets.com, Ticketfly, Eventbrite, Etix, Telecharge, and Comcast Tix.

By definition, the secondary ticket market comprises tickets that are for sale which have previously been purchased on the primary market. The secondary ticket market has grown by an amazing 25%+ per year since 2002. This explosion in the market has taken the industry from annual sales of $100 million in 2002 to an estimated $10 Billion in 2013. The secondary ticket market is roughly 22% of the $45 billion per year primary ticket market (all sports, concert, and theater tickets). With steady 10% growth, the secondary market would account for $17 Billion in annual sales by 2017.

Generally, there are two main categories of sellers who resell tickets on the secondary market. The first category comprises individuals who have season tickets and wish to sell seats for the games they cannot attend. The second category includes ticket brokers whose sole purpose in purchasing tickets from the primary market is making a profit when reselling them on the secondary ticket market, typically via one or more online ticket exchanges. Large sellers or brokers account for about 60% of total secondary market inventory, or roughly $6 billion dollars per year. Brokers rely on profits from selling sought-after tickets that have sold out on the primary market. However, ticket exchange industry leaders, such as StubHub®, charge sellers 15% per transaction, significantly cutting into a broker's profits. Exchanges also charge an additional 10-25% fee to the buyer.

### The Players:

Exchanges—Primary ticket exchanges act as intermediaries between the artist, concert promoter, sports team, sports league, etc., and the buyer. Secondary ticket exchanges act as intermediaries between secondary ticket buyers and sellers. Most exchanges take 25% of the total transaction, or $1.3 billion of estimated revenue in 2013. Although exchanges will have variances in their fee structure, it is often a 15% seller fee and 10% buyer.

The Sellers—Ticket brokers account for 60% of the $10 billion in total secondary market supply. There are a projected 3,000 ticket brokers competing in this marketplace. The average broker holds $2 million worth of inventory (i.e., tickets previously purchased on the primary market for the purpose of being resold on the secondary market). The average broker sells about 40,000 tickets per year and has an average 10,000 total listings. A listing can include one or more tickets. Average listing, including downloading and uploading tickets, takes approximately 1 minute. The average broker spends about 166 hours per year on listing tickets alone.

Presently there are no suitable options to enable sellers in the secondary ticket market to determine which tickets to buy on the primary market, and to manage ticket inventory on the secondary market. Furthermore, there are no suitable options for the management of ticket inventory on the primary and secondary markets. It is with respect to these and other considerations that the disclosure made herein is presented.

### SUMMARY OF THE INVENTION

Technologies are presented here which describe forecasting and management systems and methods concerning ticket transactions in multiple markets.

According to a first salient aspect of the invention, a method of managing ticket inventory on one or more ticket exchanges is disclosed. The method is performed by a server having memory, a processor, and one or more code sets stored in the memory and executable in the processor. The method includes the steps of receiving, at the processor, a selection of first listing data relating to a first set of one or more tickets in a user's ticket inventory; identifying, by the processor, based on the first listing data and one or more predefined user preferences, a set of available ticket listings listed on a first ticket exchange representing a first relative market with which to compare the first listing data; determining, by the processor, a current market price for the first relative market; determining, by the processor, a future market price for the first relative market; assessing, by the processor, whether the future market price exceeds the current market price; and setting, by the processor, a first listing price for the first set of one or more tickets on the first ticket exchange based on the assessing step.

The method further includes setting the first listing price above the current market price when the future market price exceeds the current market price; and setting the first listing price at or below the current market price when the future market price does not exceed the current market price. Furthermore, the method includes setting the first listing price equal to the future market price when the future market price exceeds the current market price, setting the first listing price relative to a first reference price when the future market price does not exceed the current market price; monitoring the first reference price for any change in the first reference price; and dynamically adjusting the first listing price as required to remain priced relative to the first reference price provided dynamically adjusting the first listing price would not cause the first listing price to be set outside a predetermined range.

Additionally, in some embodiments, the first reference price is one of the current market price and one of the set of available ticket listings representing the first relative market. In some embodiments, setting the first listing price relative to the first reference price further comprises setting the first listing price with a predetermined price differential relative to the reference price, the price differential being one of a dollar amount and percentage amount. Furthermore, additional aspects of the method include sending an alert when dynamically adjusting the first listing price would cause the first listing price to be set outside the predetermined range.

In some embodiments, the method further includes setting the first listing price relative to a second reference price when dynamically adjusting the first listing price would cause the first listing price to be set outside a predetermined range, wherein the second reference price is higher than the first reference price. In other embodiments, the method includes setting a second listing price for the first set of one or more tickets on a second ticket exchange of the one or more ticket exchanges based on a second relative market of the second ticket exchange; monitoring the first ticket exchange and the second ticket exchange for a purchase of the first set of one or more tickets; and removing the first set of one or more tickets from the second ticket exchange when the first set of one or more tickets are purchased on the first ticket exchange.

Furthermore, in accordance with additional aspects of the method, the method receives by the processor, a selection of second listing data relating to a second set of one or more tickets in a user's ticket inventory; sets a second listing price for the second set of one or more tickets on the first ticket exchange relative to the first listing price of the first set of one or more tickets; and dynamically adjusts the second listing price as required to remain priced relative to the first listing price. In some embodiments, setting the second listing price relative to the first listing price further comprises setting the first listing price with a predetermined price differential relative to the reference price, the price differential being one of a dollar amount and percentage amount.

According to a second salient aspect of the invention, a system on which the methods described can be implemented is also disclosed. These and other aspects, features and advantages will be understood with reference to the following description of certain embodiments of the invention.

### BRIEF DESCRIPTION OF THE FIGURES

FIG. 1 shows a high-level diagram illustrating an exemplary configuration of a forecasting and management system for ticket transaction, according to at least one embodiment of the invention;

FIG. 2 shows a broad flow diagram of a method of forecasting and managing ticketing transactions in one or more markets according to at least one embodiment of the invention;

FIG. 3 shows a detailed flow diagram illustrating elements of a method for providing forecasting and management systems and methods concerning ticket transactions in multiple markets according to at least one embodiment of the invention;

FIG. 4 shows an example screenshot of the Broker-Dash application described herein in accordance with at least one embodiment of the invention; and

FIGS. 5A and 5B show example screenshots of ticket information retrieved from an exchange server, and a user input prompt for a user to enter listing criteria, respectively, according to at least one embodiment of the invention.

### DETAILED DESCRIPTION

By way of overview and introduction, exemplary embodiments of the systems and methods of the invention described herein are intended to automate the ticket management process, including purchasing, listing, pricing, fulfillment, data entry, and accounting for sellers who list their tickets manually or via their Point of Sale (POS) infrastructure, and allows users to manage all of their electronic tickets from one interface, including, for example, editing electronic tickets and splitting them into different file types. The invention also uploads users' ticket listings seamlessly to multiple secondary ticket exchange servers and integrates with them in real time, so as to remove the risk of double-selling (selling the same tickets on more than one exchange). The embodiments of the systems and methods described herein can also be used by sellers in the primary market (e.g., teams or concert promoters selling tickets directly), and by purchasers buying tickets on the primary and/or secondary markets, to compare listings, automate selling and purchasing, and minimize costs, etc.

This is accomplished in accordance with several aspects of embodiments of the invention as described below by providing a network enabled system which allows users to access sales data from previous ticket sales and enable the system to determine the best time and/or price point at which to purchase/sell tickets, manage purchase ticket inventory, pricing, and selling, and account for profit and loss margins to enable future purchases. These concepts can be incorporated into the system as described below.

Embodiments of the system include an application called Broker-Dash comprising instructions such as code stored in memory of a server and executing in a processor of the server which communicates with the memory. The Broker-Dash application allows users to analyze millions of pieces of sales data in easy to digest charts and graphs. This helps brokers better price their inventory and make better buys in the future. The system can likewise be used by primary market sellers to list and price tickets. The Broker-Dash application is configured to access sales data from each event listed on one or more primary and/or secondary market ticket exchange servers (“exchanges servers”), for example, through an application program interface (API) associated with a ticket exchange, etc., just before the event goes offline (typically the day after the event, when tickets are no longer being sold). This data is stored into a database for future analysis. The data can include any information relevant to the listing including event name, date, zone, section, row, total sold, delivery method, date sold, artist name, team(s), day of the week, venue name, city, state, ticket splits (explained below), proximity to event, date range, etc. When the event is a sports event, the data typically includes the home team and the opposing team.

The Broker-Dash application is also configured to access current and future events to retrieve market price (price of unsold inventory) and sales data (transaction data for future events), and show trends. In addition, the system can calculate the most popular and sought-after artists and events by searching through a predetermined amount of future time, such as the upcoming four months of events, and determine which events have the highest average sold ticket price, most tickets sold etc. These data points will allow a user to see how the market is moving for a particular event in real time.

The system also includes a forecast model application comprising instructions such as code stored in memory of the server and executing in the processor, which accesses concrete sales and market data and regresses the sales and mark data based on social metrics, and generates a forecast model based on the results. By determining which social metrics show direct correlation to ticket sales, the forecast model is accurately able to predict which events (and within them, zones and sections at events) will sell at the highest profit with a high degree of accuracy.

The forecast model comprises many sets of data. First, it relies on sales and market data accessed from one or more exchange servers. Sales data from each event listed on an exchange server is saved before it expires as described above. Additionally, the system aggregates transaction data (sold tickets) and market data (unsold tickets) from all future events listed on the exchange servers, and the forecast model program incorporates this data as well. The program can receive fresh data for the next six months of events, for example, on a daily basis, or as desired.

The model relies on the fact that supply and demand determine market price. To determine demand, the program can weigh several sets of data including, for example, demographic and population data for each Designated Market Area (DMA) in which an event is held, total capacity of the venue, how many tickets were sold for comparable events, total social media popularity based on, for example, Twitter® mentions, Twitter followers, Facebook® fans, Wikipedia hits, Google® searches, YouTube® and other video sharing hits, total songs on the Billboard chart (by genre), or any other relevant social media metric and/or combination thereof. The data can all be weighed based on the DMA that the show is in.

To measure supply in accordance with embodiments of the invention, the program can note how many tickets are available in each zone at a venue and how many tickets are available in total. The system then measures how the demand would measure against the supply and if that would result in tickets staying flat, increasing, or decreasing. The program can run as many regression analyses as necessary until it is able to accurately determine predictions based on all the criteria and available data. At this point, desired tickets can be purchased by the system.

The main concept behind the forecast model is that by gaging the social “tone” within a certain DMA, the system is able to accurately predict how much consumers are willing to pay for future events based on past similar trends. This, coupled with direct data on the supply side, provides a model that provides 90%+ accurate predictions regarding which events to buy tickets for, how many to buy, when the most optimal time is to sell, and which areas of the stadium will produce the highest margins.

The system further includes an Auto-Lister application comprising code stored in memory of the server and executing on the processor, which can access order history data of primary market seller servers. After a user (ticket seller) has made a purchase from a sports team, concert promoter, theater, or venue (for example, using the forecast model program), the order details are typically stored on the backend server of the ticket issuer. The system can be configured to use the user's login credentials and access the order history portion to extract and parse all the relevant information related to the user's purchase(s), including, for example, the Event Name, Purchase Date, Order Cost, Venue, Event Date, Event Time, Section, Row, Seats, Quantity, Confirmation Number, and ticket type (electronic, paperless, or hard tickets). If the tickets are electronic, the program can download them (e.g., as pdf files) onto the system server.

The user can then log into the system and view the user's ticket data (recently pulled ticket data). The user's tickets are available there to download, split (e.g., if the user had 4 tickets and wanted to only download 2 of them), or edit (e.g., delete user's name and/or ticket list price). The user can also select the criteria for the Auto-Lister application to list the tickets on the one or more exchanges. The system can be configured by code executing in the processor to choose the correct section, as the program will take the section and compare it to any section with that value (i.e. 401 can be upper 401 or lower 401) on each exchange server. The system can be configured to select the correct section, for example, by comparing the specific specifications of each available option (e.g., seats per row, rows per section, etc.) and determining the proper match. As will be explained in detail below, the system can then receive a selection from the user of how the user would like to sell the tickets. For example, the system can employ a “make my ticket the cheapest” option which can compare the user's ticket listing to the corresponding listings for that particular zone listed on exchange servers. The user has the flexibility to set tickets as the cheapest two-pack, three-pack, etc., in the entire zone or only in that section, for example. The user can also select how to allow tickets to be sold (i.e. to list his four-pack as “Sell my ticket all together,” “Don't leave me with a single ticket,” or “sell in splits of (1,2,3, etc.).” The user can also include any additional ticket features and/or required disclosures. A feature can be, for example, a parking pass, tailgate passes, in-seat wait service, free drinks, etc. Required disclosures can include wheelchair only seat, obstructed view, etc. These can raise or lower the value of the tickets.

Then, as explain below, the system can be configured to set listings at “market price” (based on the system algorithm) or set listings at a percentage or dollar amount above or below market price, depending on user preferences. In some embodiments, the system can be configured to determine a market price by identifying the most expensive ticket listings (the highest 50%, for example) within a specific zone or area and excluding those listings from the total set of listings. The system can then be configured to take the remaining ticket listings (e.g., the remaining 50%) and average the listing prices to get a current market price. In some embodiments, the system can be configured to use predetermined user inputs. In some embodiments, the system can be configured to use machine learning to evaluate past user preferences and determine user preferences based on those past user preferences.

In accordance with further embodiments of the invention, the system can be programmed with an automatic set-pricing on all listings. For example, the system can be configured to automatically ensure that a set of tickets will be the cheapest two-pack in the user's zone or section, as well as automatically managing ticket splits (i.e. “Don't leave me with a single ticket”). The system can receive inputs representing the user selections of the listings the user wants to be auto-listed (for example, the user can select all tickets, or there may be a couple tickets the user does not want to be listed). The system can then be further configured by code executing in the processor to upload all the listing specifications (including price) and associated files as listing data into the one or more exchange servers. In addition, the system can be configured to load ticket data into POS systems. Additionally, an Auto-Pricer application (described below) can be integrated with the Auto-Lister application. A user can employ the systems and methods described herein to select auto pricing at the time the user lists the tickets.

Below is a brief overview of how the Auto-Lister lists tickets in accordance with embodiments of the invention:
1. User enters system account credentials.
2. The system sends an http request to the server and confirms the login details.
3. If authentication fails, a prompt message is shown to enter the details again.
4. If credentials are correct the user will be able to select the listings which the user wants to list on an exchange server.
5. The system is configured to send a request to the exchange server and query the data; the returned data includes the user preferences for listing the tickets and the ticket details, along with the preferences the desktop app downloads the corresponding tickets.

Examples of the information returned from the server is contained in the following tables:
Events Database

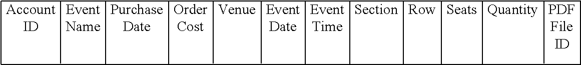

PDF Files Table

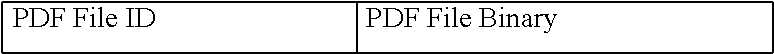

Preferences Table

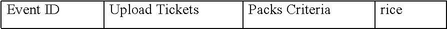

6. The information is processed by the system and the tickets are uploaded.

The system can be further configured by the auto-lister application to check the date of the event, in which there are three possible conditions: date is not given (i.e., TBD), date is a single date, or date is ranged. To determine the correct date, the system can then be configured to search for event name, for example by accessing a search engine, e.g. on the Internet or a search engine of the actual exchange where tickets are listed and/or an API of the exchange, by entering the event name and date(s) and finding the correct event. The system can then be configured to access the event on the desired exchange server, and upload the tickets. Ticket data can also be received by parsing confirmation e-mails (e.g, accessing an e-mail client) and/or by extracting PDFs from e-mail attachments and parsing the PDFs. Based on user preference, there are four (4) different delivery methods for tickets: Tickets can be mailed via mail carrier, tickets can be in PDF format and user does not want to upload the PDF, ticket is in PDF and user wants to upload the PDF, or tickets can be listed for “local pickup.” Based on user preferences, the system can upload the tickets to be listed in the desired manner.

Brokers typically price their tickets in one of two ways: they either price high because they believe the market will go up, or they price at “market price” so that they can sell their tickets now at as high of a price as possible. When brokers “price to sell,” they determine “market price” based on comparable tickets that a buyer might be looking for. There are several factors that brokers consider when they are trying to be within market range:
1. Their particular “zone” in the stadium. Each zone is generally comprised of several different sections. The zones are divided by location within a stadium. A basic example would be a stadium comprising three zones: Upper, Middle, and Lower.
2. Their section within that zone. For example, Upper level sideline at a football stadium may contain sections that range anywhere from the 15 yard line to the 50 yard line. Even though all these sections are the highest level in the stadium, buyers will generally pay a premium for tickets closer to the 50 yard line. Therefore, a seller would base the price off of a few similar sections within that zone, but not the entire zone.
3. The ticket split. This refers to how many seats the seller has together. The reason this is important is that there are many times where there are many tickets in a particular area but the large majority are two-packs. If, for example, a seller is the only four-pack in that section, the seller's tickets may be worth 100% more than the two-packs next to those tickets even in the same row.
4. Row range. Typically, the lower the row the higher the ticket price in that zone/section. Therefore, a seller with row 1 tickets who wants to be the cheapest two-pack within a specific range will not typically be competing against another broker with row 15 tickets. The seller may opt to be the cheapest in the first 5 rows, for example.
5. Delivery method. Electronic delivery and instant download tickets are often priced higher than mail carrier ticket delivery. This is due to the fact that buyers can be impatient and would pay $20 more to have the tickets immediately, rather than to wait for them to arrive via mail carrier. In addition, the cost for mail delivery can be upwards of $17, as opposed to $6 for e-delivery. Therefore, a user (seller) may be pricing against all electronic tickets in an area but not all tickets (including mail carrier delivery).

The system therefore further includes an Auto-Pricer application, comprising code stored in memory of the server and executing on the processor. The Auto-Pricer instructs the system to pull all of a seller's inventory data from either an exchange server's back end (database) or from the seller's POS. The system can then be configured to filter the listings, for example, by date range and by artist/team. A user's imported listings include the event information such as artist, date, zone/section, row, seats, and quantity for each event. When a user selects a listing, the user is able to choose which tickets or type of tickets to price against, as described above. The system receives a selection of either all delivery methods or only the specific delivery methods the user wants to beat (e.g., instant download only). The system then receives a selection of the ticket split (e.g., if the user has a four-pack, the user can choose to be the cheapest two-pack or the cheapest four-pack). The Auto-Pricer application then configures the system to pull all the zone information based on the user criteria and displays current lowest price in each area. The user can select the zone(s) the user wants to price against and Auto-Pricer application moves the listings to those sections, which also show the lowest pricing based on the user's preset criteria. The user can either select all of the sections or specific sections to be accounted for. Finally, after choosing the sections, the program can display all the rows with the selected criteria. The user selects the row range to be priced against.

At this point, the user can determine whether to be the cheapest, second-cheapest, or third-cheapest in that criteria, for example. The user can then choose whether to be lower or higher than the lowest price by an amount (e.g., $0.03) or percentage. The user can then select a price floor, which can indicate the point at which the Auto-Pricer application will discontinue automatically adjusting ticket prices, and/or at which point the system will automatically notify the user (e.g., via text message or e-mail) that the price floor has been reached. Likewise the user can select a price ceiling, which effectively this creates a “price range” at the boundaries of which the Auto-Pricer application would be triggered. So if a price floor was $50 and a price ceiling was $100, the listings would only auto-adjust within that defined range. The system then can be configured to monitor all pricing in that preset value to ensure the user's tickets are always priced exactly where the user wants them. In some embodiments, the program will only lower the user's set price until the set price reaches the price floor. At that point, an email or other notification can be sent informing the user that the floor had been reached and asking if the user wants to edit the selected information. In some embodiments, e-mail notification can be based on market volatility, e.g., many price changes in a short period of time. When the user logs back into the user account, any overvalued inventory can be highlighted, for example, in red.

In accordance with embodiments of the invention, this program can also be integrated with POS's. The system can be configured to send a new price file into the POS which contains the pricing based on the user's request. A user can also decide which exchange or exchanges to price against. For example, a user who sells most of his or her inventory through one exchange server could choose to auto price based on that exchange server market pricing and not another exchange server. This program can also work to simply send notifications/alerts in lieu of changing pricing. The system can be configured to send notifications based on a user's frequency preferences, letting the user know how many tickets are out of market range. The program can also notify the user separately for every listing.

In addition to alerts for price floors and ceilings, other alerts can be implemented, such as alerts which tell users they are either priced too high, too low, or that the market is trending closer or further away from the user's target price. Particularly with regard to the forecast elements of the auto-pricer, if the future market price is the user's target, that price can always fluctuate based on several factors. Therefore, if the auto-pricer application had been set to price high initially based on the forecast telling the user that the target price was three weeks away, and the price actually trends down, the alert can inform the user to reset the criteria or could instruct the system to automatically adjust.

Once tickets are purchased, in accordance with embodiments of this invention, a ticket issuer on the primary market can either deliver tickets in a conventional manner, or can use the systems and methods described herein to provide an optional delivery system employing finger print recognition technology that serves as a central Point of Sale to a team, promoter, and/or Venue. Specifically, a purchaser creates an account with the ticket issuer and, using a smartphone or tablet, either uses a finger scanner or takes a picture of his or her right index finger to record a fingerprint. The purchaser's finger print is stored in a database and is associated with the purchaser's account. When the purchaser purchases any seat from the issuer in the future (from any venue that has the issuer's POS installed) the purchaser simply goes to the stadium and presses his/her finger on a fingerprint scanner at the issuer's kiosk or at designated gates. The system can instantly recognize the purchaser's identity and print the corresponding ticket (i.e Section 303, row D, seats 1-4), or indicates to a gate attendant that the purchaser may enter. A purchaser that buys multiple tickets can scan one finger to provide entry for multiple additional guests. In some embodiments, the system can include a proprietary or standard merchant gateway which will also utilize the same technology. Purchasers can also opt for electronic or hard tickets. Scanning devices at the stadium will be capable of reading bar codes and fingerprints.

Furthermore, the system described herein can be used to provide ticket purchasers with an opportunity to purchase other goods and services, such as food items, souvenirs, guest services, etc., prior to arriving at an event. Any goods or services purchased before the event can be associated with the purchaser's user account. When the ticket purchaser arrives at the event, the purchaser can use the fingerprint provided earlier to access the other purchases via an express lane or pick-up service, or have such purchases delivered directly to the seat associated with the ticket a predetermined time or when requested.

Finally, users need to keep track of inventory and profits & losses (“P & L”). The system therefore also includes an Auto-Accountant application comprising code stored in memory of the server and executing on the processor, which can work in conjunction with the Auto-Lister application. The system executes the application code to extract all a seller's data from the seller's back end system so that the system knows how much each listing cost the seller to purchase. The system can also extract all sales data from each exchange server back end and/or from email confirmations received by the seller. The sales data can then be manipulated to show the total profit. In this way, the system is also configured to determine how much unsold inventory a user has. Moreover, the system can take the current inventory and allow the user to see what true market value is all-time or within a specific date range. The system does this by comparing the listings to exchange server listings and gives pricing, for example, based on the cheapest two-pack within the relevant section. While this is not exactly market price, it is a close indication.

These and other aspects, features and advantages will be understood with reference to the following description of the figures with regards to certain embodiments of the invention.

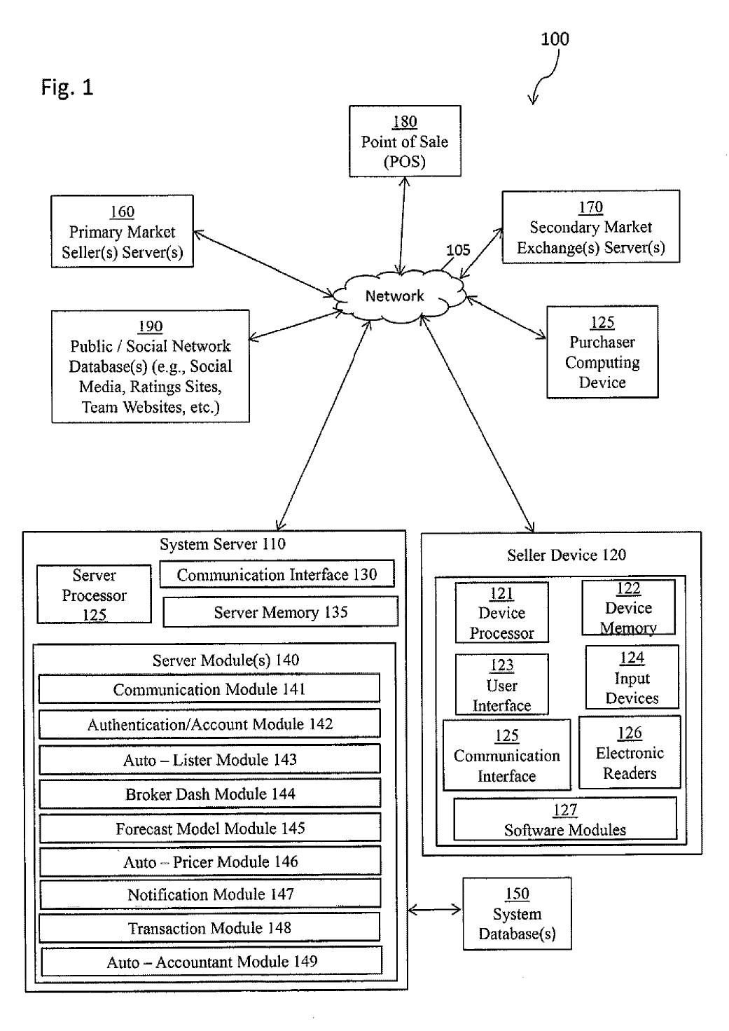

Turning now to FIG. 1, the schematic block diagram illustrates a distributed network system 100 including network 105, which can comprise the Internet, one or more telephony networks, one or more network segments including local area networks (LAN) and wide area networks (WAN), one or more wireless networks, or a combination thereof. System 100 also includes a system server 110 constructed in accordance with one or more implementations of the invention. The system server 110 communicates over network 105 with multiple other processing machines such as computers, and more specifically stationary devices, mobile devices, and computer servers (collectively, “computing devices”). Communication with these computing devices can be either direct or indirect through further machines that are accessible to the network 105.

The system server 110 can be practically any computing device and/or data processing apparatus capable of communicating with computing devices, and other remote devices or computing networks, receiving, transmitting and storing electronic information and processing requests as further described herein. System server 110 is therefore intended to represent various forms of digital computers, such as laptops, desktops, workstations, personal digital assistants, servers, blade servers, mainframes, and other appropriate computers and/or networked or cloud based computing systems capable of employing the systems and methods described herein.

Among the computing devices on the network 105 are user devices which can include seller device 120 and purchaser device 125. As understood herein, in accordance with one or more embodiments, a computing device can be a stationary computing device, such as a desktop computer, kiosk and/or other machine, each of which generally is understood in the art as having one or more processors configured to execute code to implement a variety of functions, a computer-readable memory, one or more input devices, one or more output devices, and a communication port for connecting to the network 105. Typical input devices can include a keyboard, pointing device (e.g., mouse or digitized stylus), a web-camera, and/or a touch-sensitive display, etc.

Additionally or alternatively, a computing device can be a mobile electronic device (“MED”), which is generally understood in the art as having hardware components as in the stationary device described above, and being capable of embodying the systems and/or methods described herein, but which may further include componentry such as wireless communications circuitry, gyroscopes, inertia detection circuits, geolocation circuitry, touch sensitivity, among other sensors. Non-limiting examples of typical MEDs are smartphones, personal digital assistants, tablet computers, and the like, which can communicate over cellular, infrared, and/or Wi-Fi networks or using a Bluetooth or other communication protocol. Typical input devices associated with conventional MEDs include, keyboards, microphones, accelerometers, touch screens, light meters, digital cameras, and the input jacks that enable attachment of further devices, etc.

The system server 110 can include a server processor 125 which is operatively connected to various hardware and software components that serve to enable operation of the system 100. Server processor 125 serves to execute instructions such as code to perform various operations relating to ticket inventory management processing as will be described in greater detail below. Server processor 125 can be a number of processors, a central processing unit CPU, a graphics processing unit GPU, a multi-processor core, or any other type of processor, depending on the particular implementation. System server 110 can be configured to communicate via a communication interface 130 with various other devices connected to network 105. Preferably, communication interface 130 can include but is not limited to, a modem, a Network Interface Card (NIC), an integrated network interface, a radio frequency transmitter/receiver (e.g., Bluetooth, cellular, NFC), a satellite communication transmitter/receiver, an infrared port, a USB connection, and/or any other such interfaces for connecting the system server 110 to other computing devices and/or communication networks such as private networks and the Internet.

In certain implementations, a server memory 135 is accessible by server processor 125, thereby enabling server processor 125 to receive and execute instructions stored on the memory and/or storage in the form of one or more server software modules 140. The server modules 140 can comprise one or more software programs or applications (collectively referred to as the “server application”) having computer program code or a set of instructions executed in the processor 125 for carrying out operations for aspects of the systems and methods disclosed herein, and can be written in any combination of one or more programming languages. As shown in FIG. 1, the exemplary software modules can include a communication module 141, an authentication/account module 142, auto-listing module 143a, broker-dash module 144, a forecast model module 145, an auto-pricing module 146, a notification module 147, a transaction module 148, and an auto-accountant module 149. It should be noted that in accordance with various embodiments of the invention, server modules 140 can execute entirely on system server 110 as a stand-alone software package, partly on system server 110 and partly on the computing devices 115 and/or 120, or entirely on devices 115 and/or 120.

Server memory 135 can be, for example, a random access memory (RAM) or any other suitable volatile or non-volatile computer readable storage medium. Server memory 130 can also include storage which can take various forms, depending on the particular implementation. For example, the storage can contain one or more components or devices such as a hard drive, a flash memory, a rewritable optical disk, a rewritable magnetic tape, or some combination of the above. In addition, the memory and/or storage can be fixed or removable. In addition, memory and/or storage can be local to the system server 110 or located remotely. In accordance with further embodiments of the invention, system server 110 can be connected to one or more system database(s) 150. System database 150 can comprise any of the memory configurations as described above, and is in direct communication with system server 110.

As shown in FIG. 1, a typical computing device, for example seller device 120, includes various hardware and software components that serve to enable operation of the system 100, including one or more device processors 121, a device memory 122, a user interface 123, one or more input devices 124, a communication interface 125, one or more electronic readers 126, and one or more software modules 127. As with server processor 125, device processor 121 can be a number of processors, a central processing unit CPU, a graphics processing unit GPU, a multi-processor core, or any other type of processor, depending on the particular implementation. Likewise, device memory 122 is accessible by device processor 121, thereby enabling the processor to receive and execute instructions encoded in the memory so as to cause the computing device and its various hardware components to carry out operations for aspects of the exemplary systems and methods disclosed herein. Device memory 122 can comprise one or more of the memory configurations as described above with reference to server memory 135.

The user interface 123 is also operatively connected to device processor 121. User interface 123 can comprise a display and/or graphical inputs displayed thereon, which can serve to facilitate both the providing of information to a user and as an input device, depending on the particular hardware and software. Also connected to the device processor 121 is the one or more input and/or output device(s) 124, such as switch(es), button(s), key(s), a touch-screen, microphone, etc., as would be understood in the art of electronic computing devices. Input devices 124, which can be used in conjunction with user interface 123 or on their own, serve to capture commands and/or actions from the user such as on-off commands, user-provided information, settings adjustments, and/or any relevant user interaction with the computing device related to operation of the system 100.

Communication interface 125 is also operatively connected to the device processor 121 and can be any interface that enables communication between the computing device and external devices, machines and/or elements. As with the server communication interface 130, the device communication interface 125 can include but is not limited to, a modem, a Network Interface Card (NIC), an integrated network interface, a radio frequency transmitter/receiver (e.g., Bluetooth, cellular, NFC), a satellite communication transmitter/receiver, an infrared port, a USB connection, and/or any other such interfaces for connecting the computing device to communication interface 130 of system server 110 and/or other computing devices and/or communication networks such as private networks and the Internet. Such connections can include a wired connection and/or a wireless connection (e.g., using the 802.11 standard), though it should be understood that the communication interface can be practically any interface that enables communication to/from the computing device.

The one or more electronic readers 126 can be operatively connected to the device processor 121. The electronic reader can serve to facilitate the capture of electronic information from tickets. For example, in the context of a mobile point of sale (MPOS) transaction, seller device 120 can be equipped with a camera or other scanner for capturing a digital image of, or data from, a bar-code on a ticket. By way of further example, the electronic reader can also be a NFC-enabled reader that can read data from a NFC enabled chip or RFID tag of another device.

The one or more device modules 127 comprise instructions such as code and are encoded in the memory 122 of the computing device. The software modules can comprise one or more software programs or applications having computer program code or a set of instructions (collectively referred to as the “client application”) executed in device processor 121. Such computer program code or instructions configure device processor 121 to carry out operations of the systems and methods disclosed herein and can be written in any combination of one or more programming languages. It should be noted that in accordance with embodiments of the invention, device modules 127 can execute entirely on computing devices 120 and/or 125 as a stand-alone software package, partly on the computing device and partly on system server 110, or entirely on system server 110.

It should also be noted that while in FIG. 1 the two computing devices 120 and 125 are designated as a “seller device” and a “purchaser device” respectively, the computing devices do not necessarily have to belong to the seller and/or the purchaser; rather, these designations simply indicate the respective user's ability to access and use the computing device in accordance with embodiments of the invention. Furthermore, one device can be used for both selling and purchasing of tickets, and therefore the designations of “seller device” and “purchaser device” should not be understood as limiting. As used herein, a “user” can be understood as one engaging with the system, as a seller and/or as a purchaser.

As stated above, system server 110 communicates over network 105 with multiple other computing devices such as servers. System 100 further includes one or more Primary Market seller servers 160, and/or one or more Secondary Market exchange servers 170. As explained in detail above, Primary Market seller servers 160 can include, for example, the ticket management systems of one or more primary market ticket exchanges which sell tickets on behalf of sports teams, concert promoters, etc., or can represent the ticket management systems of the actual entities themselves providing the tickets directly to purchasers. Likewise, Secondary Market exchange servers 170 can include, for example, the ticket management systems of one or more secondary market exchanges which enable the buying and selling of tickets previously purchased in the primary market. Secure server 110 can communicate over network 105 with these servers for purposes of facilitating ticket purchases and sales on the various exchanges, as well as for retrieving (downloading) and sending (uploading) ticket inventory data to and from these exchanges as required.

Additionally, system 100 includes one or more POS(s) 180. System server 110 can communicate directly with a ticket broker's POS 180 via network 105, to enable sellers to easily manage inventory being sold via the POS 180. Finally, system 100 includes one or more Public/Social Network Database(s) 190, which can include, for example, Social Media (e.g, Facebook, Twitter, etc.), Ratings Sites (e.g., Billboard), Team Websites, etc. System server 110 is configured to communicate with the various Public/Social Network Database(s) 190 to retrieve real-time and archived information (data) which can be used by the system server 110 to determine which tickets to purchase, at what price to list tickets, and when to sell tickets and replenish inventory as described above.

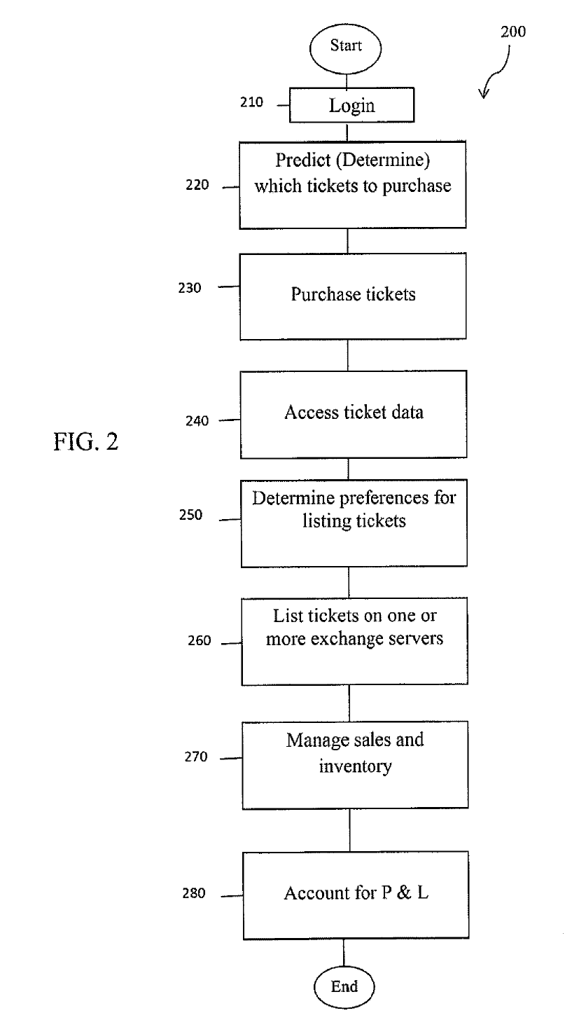

Turning now to FIG. 2, a broad flow diagram of a method 200 of forecasting and managing ticketing transactions in one or more markets is briefly described in accordance with embodiments of the invention. Method 200 begins at step 210, when a user is provided with a log in window on seller device 115 and enters account credentials for authentication purposes. Once authenticated, at step 220 a user can access the Broker-Dash application and/or the Forecasting Model application and input user-provided criteria (e.g., general location, genre, budget, etc.) to enable the system 100 to predict (determine) which tickets to purchase. At step 230, the system 100 can be configured to purchase the ticket(s) determined to comply with the user-provided criteria. At step 240, system 100 can execute the Auto-Lister application to access the ticket data on exchange at which the tickets were purchased, retrieve the ticket data, and determine the corresponding event and location of the seats represented by the ticket data.

At step 250, the system 100 can determine the optimal preferences for listing the previously purchased tickets based on one or more of the broker-dash information, forecast model information, predefined user inputs for these tickets, and/or machine learning of previous listings. At step 260, system 100 can be configured to list the tickets in the proper location on each of one or more exchanges, and can execute the Auto-Pricer application to adjust ticket prices and/or listings as required within each exchange and/or across exchanges (as explained in further detail below). At step 270, system 100 can be configured to manage sales of tickets listed on various exchanges, and can further be configured to automatically replenish inventory as required, based on predefined user preferences. Finally, at step 280, system 200 can execute the Auto-Accountant application to manage profits and losses, as well as to assist in inventory replenishment, and the method ends.

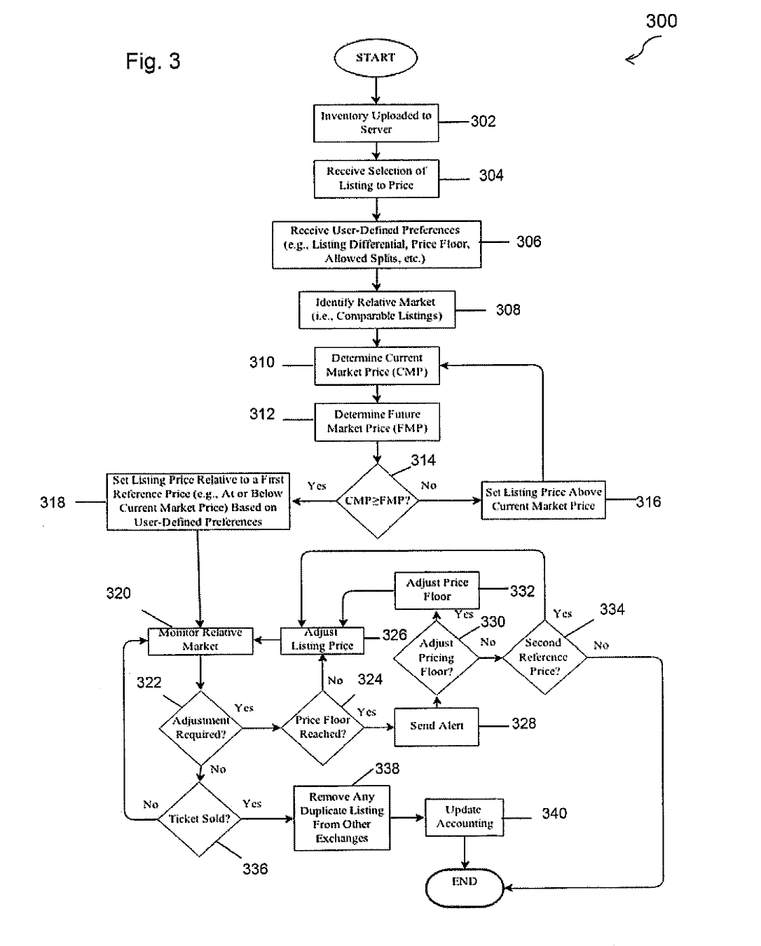

Turning now to FIG. 3, a detailed flow diagram illustrating elements of a method for providing forecasting and management systems and methods concerning ticket transactions in multiple markets according to embodiments of the invention is provided. Generally, Method 300 describes the steps for pricing, listing, and managing ticket inventory on one or more ticket exchanges, for example, using system 100. Method 300 starts at step 302 when system server 110, using server processor 125 which is configured by executing one or more server modules 140, including, preferably, communication module 141, retrieves a set of ticket information related to one or more tickets or sets of tickets. As explained above, such tickets may have been purchased by the user on either the primary market or the secondary market, or may be original tickets generated by a vendor (e.g., a primary market exchange seller, a sports franchise, a concert promoter, etc.). In some implementations, the ticketing information is generated or provided by one or more of Primary Market seller servers 160, and/or one or more Secondary Market exchange servers 170, and is communicated over network 105 to system server 110. In order to access and retrieve ticket information (inventory) from Primary Market seller servers 160 and/or Secondary Market exchange servers 170, server processor 125 can be configured to execute instructions such as code from server memory 135 that communicates with server processor 125 represented by authentication/account module 142, to provide user login information necessary for accessing the desired information on such servers.

As explained above, ticketing information can optionally include, for example, one or more of the following: the Event Name, Purchase Date, Order Cost, Venue, Event Date, Event Time, Section, Row, Seats, Quantity, Confirmation Number, and ticket type (electronic, paperless, or hard tickets). If the tickets are electronic, system server 110 is configured by code represented by communication module 141 and executing in system processor 125 to download them (e.g., as .pdf files) into system database 150. System server 110 can be configured to retrieve ticket information using, for example, Optical Character Recognition (OCR) software and/or by querying the exchange server from which ticket information is being retrieved for specific data or data types.

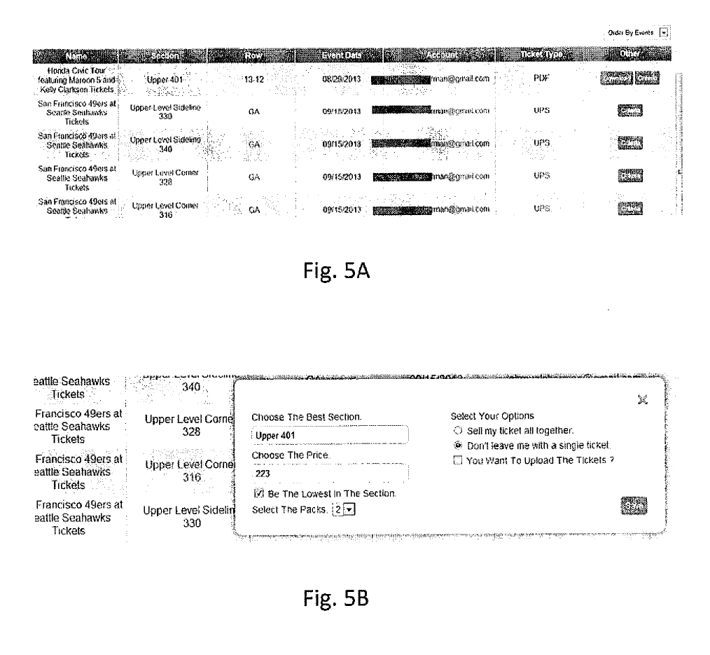

As explained in detail above, in some embodiments, system server 110 can be configured to determine the best match for ticketing information listing purposes (e.g., by querying the relevant ticket exchange server or the Internet), or the user can be prompted to provide such information in the event the system cannot accurately determine the proper listing criteria for the ticket information. Turning briefly to FIGS. 5A and 5B, example screenshots of ticket information retrieved from an exchange server and uploaded to system server 110, as well as a user input prompt for a user to enter listing criteria are shown respectively. As noted above, in some embodiments such listing criteria can be predefined and/or intuitively learned by the system server 110 over time using machine learning functionality.

Returning to FIG. 3, at step 304 server processor 125 executes instructions such as code from server memory 135 that communicates with server processor 125 represented by communication module 141 to receive a selection of one or more particular listings to be priced from among the ticket inventory available in system database 150. In some embodiments a selection can be initiated by a user, while in other embodiments a selection can be automatically made by system server 110 based on predefined priority criteria such as, for example, the date of an event, the initial purchase price of a ticket, social tone (described above), location, etc. Then, at step 306, server processor 125 executes instructions such as code from server memory 135 that communicates with server processor 125 represented by communication module 141 to receive user-defined preferences for listing purposes. This can include, for example, a listing differential (i.e., a pre-set difference in dollar amount or percentage amount between a ticket to be listed and one or more reference prices, such as those of other similar tickets currently listed on one or more exchanges), a price floor (and/or price ceiling), allowed splits (e.g., “don't leave me with one ticket” or only even groupings of tickets), etc. As explained below, a reference price can be dynamic (changing as market prices change) or static (constant regardless of market fluctuation), and can refer to particular listings and their corresponding prices (e.g., specific tickets listed on an exchange) or can refer to a ranking/location in a hierarchy (e.g., lowest presently listed ticket in the same section or second-cheapest listed two-pack in the same zone).

At step 308, system server 110 using server processor 125 which is configured by executing one or more server modules 140, including, preferably, Auto-Listing module 143, can identify a relative market against which the selection of one or more particular listings are to be priced. In some embodiments, a relative market can comprise a group of one or more comparable listings listed on the same exchange, which can include, for example, other tickets in the same general vicinity (e.g., same, row, same section, etc.) or equivalent seats at another location at the venue (e.g., gallery seating on opposite sides for a theatre). Furthermore, a relative market can comprise a group of comparable listings listed on other exchanges, in addition to, or in place of, comparable listings on the same exchange. Additionally, a relative market can comprise similar and/or the same ticket listing(s) listed on a different but relatively similar date or at different time on the same date (e.g., when there are multiple showings of an event throughout the day).

At step 310, system server 110 using server processor 125 which is configured by executing one or more server modules 140, including, preferably, Auto-Listing module 143, can determine a Current Market Price (CMP) for the relative market against which the selection of one or more particular listings are to be priced. This can be accomplished, in accordance with some embodiments of the invention, using a multi-step process. First, any listings which have not yet been “priced to sell” (e.g., tickets temporarily listed with prices that are intentionally inflated well above their market value and out of market range, until the owner is ready to sell the tickets at a competitive price) are identified and removed from consideration. As explained above, in some embodiments, for example, a percentage of the highest priced tickets can be removed. In other embodiments, any tickets with prices set outside a predefined range can be removed. For example, the upper sideline area of a stadium, (which can include, for example, 12 or more sections) may have 10 listings, with the bottom five ranging from $100-$150, and the top five all listed at $500+. In this example, the top five listings will not be considered part of market range, as they may have been posted at an intentionally high price so that they do not sell (e.g., if the broker is not ready to sell, but would like to have them listed nonetheless), or they may have been inadvertently overpriced. Regardless, once the overpriced tickets have been removed from consideration, an average of the remaining listings can then be calculated in order to determine the CMP.

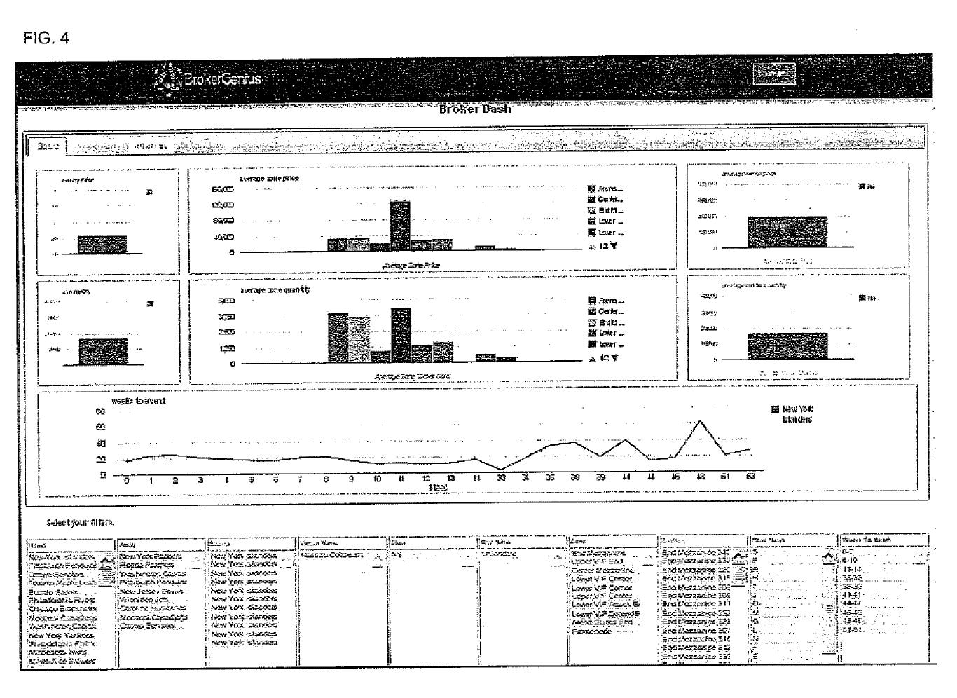

At step 312, system server 110 using server processor 125, which is configured by executing one or more server modules 140, including, preferably, broker-dash module 144 and forecast model module 145, can determine a Future Market Price (FMP), such as the maximum estimated FMP, for the remaining listings. As explained above, broker-dash module 144 is configured to access information relating to current and future events to retrieve market price data (price of unsold inventory) and sales data (transaction data for future events), and identify trends. Briefly, a screenshot of the broker-dash application represented by broker-dash module 144 is shown in FIG. 4. In some embodiments server processor 125 can execute broker-dash module 144 to determine which way the market is moving (trending) for a particular event in real time based on these identified trends. Likewise, in some embodiments server processor 125 can execute forecast model module 145, which accesses concrete sales and market data, regresses the sales and mark data based on social metrics, and generates a forecast model based on the results. By determining which social metrics show direct and/or indirect correlation to ticket sales, the forecast model is accurately able to predict which events (and within them, seats, rows, zones, and sections, etc., at events) will sell at the highest profit with a high degree of accuracy. Broker-dash module 144 and/or forecast model module 145 can thus be used by system server 110 to determine the FMP for the remaining listings, and enable the system to determine at which point in time and at what price point to list the remaining listings, as explained below.

At step 314, system server 110 using server processor 125 which is configured by executing one or more server modules 140, including, preferably, Auto-Listing module 143, can use the CMP and FMP, calculated in steps 310 and 312 respectively, to determine whether to begin pricing the remaining listings “to sell” (i.e., at a competitive price point), or whether to intentionally price the listings out of market range for the time being, e.g., at a predetermined price point or percentage about the CMP. If the CMP is less that the FMP (i.e., CMP is not greater than or equal to FMP), this indicates that the tickets have not yet reached their highest potential selling value point (earning potential). In this case, the method continues at step 316, wherein the system is configured to set the listing price at a predefined price or percentage above the CMP. The CMP and FMP can thereafter be recalculated periodically or constantly (i.e., in “real-time”) until the system determines that the tickets should be priced to sell. However, if (at step 314) the CMP is determined to be greater than or equal to the FMP, indicating it is the peak time to competitively price the tickets, then at step 318, system server 110 using server processor 125 which is configured by executing one or more server modules 140, including, preferably, Auto-Pricing module 146, can set the listing price of the tickets at a price relative to a first reference price (e.g., at, below, or above the CMP) based on user-defined preferences as described below.

A reference price, as understood herein in accordance with various embodiments of the invention, is any predefined price point (e.g., dollar value) against which the price of a user's listing can be calculated/defined. As described above, a reference price can be dynamic (changing as market prices change) or static (constant regardless of market fluctuation), and can refer to particular listings and their corresponding price points (e.g., specific tickets listed on an exchange) or can refer to a ranking/location in a hierarchy (e.g., lowest presently listed ticket in the same section or second-cheapest listed two-pack in the same zone). In some embodiments, this can include a price point calculated based on a plurality of listings (e.g., an average of the three lowest comparable listings). In some embodiments the reference point can be, for example, the CMP. In some embodiments, users can be direct to select a first (primary) reference price, and second (alternative) reference price. In the event that the first reference price is no longer relevant, the system can default to the second reference price, as described below.

Once a first reference point has been defined, at step 318 the system can be configured to determine a listing price for the selection of one or more particular listings based on the first reference price. For example, a listing differential (i.e., a pre-set difference in dollar amount or percentage amount between a ticket to be listed and one or more reference prices, such as those of other similar tickets currently listed on an exchange) can be used. A user may desire, for example, to have a listing priced at 250 above the lowest priced comparable listing at all times, at $1 below the lowest comparable listing, subject to a price floor (as described below), or may desire to have a listing priced 3% cheaper than the CMP. Of course, more complex pricing rules can also be implemented, such as alternative pricing. In some embodiments, a user can use the system to define more than one reference price. For example, as discussed further below with reference to step 334, a user can create one or more alternate (e.g., second, third, etc.) reference prices which can be used by the system in the event a first reference price becomes ineffectual or otherwise unusable for the user based on, for example, changing market prices.

At step 320, once listing prices have been set for the selection of one or more particular listings, system server 110 using server processor 125 which is configured by executing one or more server modules 140, including, preferably, Auto-Pricing module 146, is configured to monitor the relative market (identified in step 308) against which the selection of one or more particular listings was priced for any material change in the relative market. Monitoring can be performed in “real-time” or can be intermittent. As understood herein, a material change is any change that would materially affect the calculation of the CMP, the FMP, and/or the listing price of the selection of one or more particular listings such that a user might be inclined to a modify the set listing price of the selection. Of course, it will be readily understood by those skilled in the arts that there can be a certain level of tolerance for changes in the relative market that would be considered immaterial, for example, when all tickets in the relative market fluctuate at the same rate relative to one another. Therefore, in some embodiments, users can be prompted to set and/or adjust the sensitivity of the monitoring as desired based on market fluctuation, sales of tickets, etc.

It should be noted that, in some embodiments, if, during the monitoring of the selection of one or more particular listings and the relative market, any tickets from the relative market are purchased, system 100 can be configured to automatically revert to step 308 to identify a new relative market and recalculate the CMP and FMP, etc. Likewise, system 100 can be configured to monitor new listings which qualify as being part of the identified relative market when posted. In various embodiments, such a new listing may replace a previously incorporated listing or may be considered in conjunction with all previously identified listings in the relative market.

At step 322, in response to the monitoring of step 320, system server 110 using server processor 125 which is configured by executing one or more server modules 140, including, preferably, Auto-Pricing module 146, is configured to determine whether adjustment to the set listing price of the selection of one or more particular listings is required. As discussed above, fluctuation in the relative market may or may not necessitate adjusting the set listing price. For example, if changes to listings in the relative market do not impact the location of the user's listings in the pricing hierarchy, no adjustment may be necessary. If no adjustment in the listing price is necessary, the system will continue to monitor the selection of listings for any sales (as explained below at step 336), as well as any changes in the relative market.

If the system determines that an adjustment of the listing price is required in order for the selection of listings to remain relatively priced with regard to the first reference price, then at step 324 system server 110, using server processor 125 which is configured by executing one or more server modules 140, including, preferably, Auto-Pricing module 146, is configured to first determine whether adjusting the listing price would be a violation of the user's predefined listing preferences (see step 318). For example, in embodiments wherein the user has previously defined a price floor (i.e., a lowest allowable listing price) for the selection of one or more particular listings, system server 110 is configured to determine whether the price floor would be reached by adjusting the listing price as required. By setting a price floor, a user can ensure that listing prices are not inadvertently set below the user's lowest acceptable selling price.

Provided the user's predefined listing preferences would not be violated (e.g., the price floor is not reached), then, at step 326, the listing price is adjusted by the system as required, and monitoring of the relative market continues at step 320. If, however, adjusting the listing price would cause the user-defined preferences to be violated, then, in accordance with some embodiments of the invention, at step 328, system server 110, using server processor 125 which is configured by executing one or more server modules 140, including, preferably, notification module 147, can be configured to notify/alert the user that the user-defined preferences must be modified if the selection of listings is to remain priced as the user desires in relation to the relative market. For example, system server 110 can be configured to inform the user via any standard digital notification/communication system, such as via e-mail, text message, Instant Message, automated voicemail, pop-up notification, etc., that a price floor has been reached for a particular listing or for a set of listings. Additionally, the system can be configured to provide suggested modifications, such as a suggested adjusted price floor.

Furthermore, in some embodiments, the user can be requested to provide guidance to the system in the form of a response. For example, at step 330 system server 110 can be configured to determine whether an instruction has been received from the user to adjust the price floor to an indicated or predetermined amount (e.g., $10 lower than the previous price floor), thereby allowing the system to adjust the listing price accordingly. If an instruction has been received or if, for example, an alternative price floor has been provided previously, then at step 332 the price floor is adjusted and at step 326 the listing price is adjusted, and monitoring continues. If, however, no instruction is received regarding adjustment of the price floor (e.g., in a predetermined period of time), at step 334 the system can be configure to determine if a second (alternative) reference price has been previously provided with the user-defined preferences in step 318. Alternatively, the user can be requested to provide a second reference price via the notification of step 328. In either situation, if system server 110 can identify a second reference price, then at step 326 system server 110 can be configured to adjust the listing price to a price relative to the second (alternative) reference price, without adjusting the price floor, presuming one has been provided by the user at step 318.

In some embodiments, if no alternative price floor is provided and no alternative reference point is provided, then the selection of one or more listings will remain at the original price point. In some embodiments, the price point of the listings can be adjusted to the first price floor, and will remain there unless the user provides input or the relative market raises enough to affect the listing price. Finally, in some embodiments, the system server 110 can be configured to reset the tickets to a price above the CMP or pull the listings entirely from the server. This may be the case, for instance, when ticket prices of the relative market are falling on one ticket exchange, but remain higher on another exchange. In such a situation, system server 110 using server processor 125 which is configured by executing one or more server modules 140, including, preferably, Auto-Listing module 143, can remove the selection of one or more particular listings from the falling market (or raise the price above the CMP) and list them on the higher market. In some embodiments, such as wherein tickets are listed on multiple exchanges simultaneously, the system can be configured to monitor all exchanges (and the relative market of each), and adjust listing prices accordingly, thus enabling the system to capitalize on the best market.

At step 336, system server 110 using server processor 125 which is configured by executing one or more server modules 140, including, preferably, transaction module 148, is configured to monitor the selection of one or more tickets on each market on which the tickets are listed to determine if they have been purchased. In embodiments where the user is the ticket issuer, purchased tickets can be processed and delivered to the buyer in the manner selected by the purchaser (e.g., via mail, e-mail, will-call, etc.).

Once the system detects that the tickets have been purchased on one exchange, at step 338 the system server 110 is configured to remove any duplicate listings from other exchanges where the tickets have been listed to avoid any possibility of double-selling (inadvertently selling the same tickets to multiple purchasers via different ticket exchanges). Finally, at step 340, system server 110 using server processor 125 which is configured by executing one or more server modules 140, including, preferably, Auto-Accountant module 149, can update the Auto-Accountant application (described in detail above), and the system ends.

Of course, the systems and methods described herein can include additional features in order for the user to maximize profitability and minimize on time spend managing inventory. For example, a Season Pricer application can be incorporated which allows users to select a group of seats, select the criteria for the entire season, and then choose different floors for different tier games (premium games would have a higher floor and so on).

It should be noted that while the present application primarily describes features of the various embodiments from the perspective of the seller, those of ordinary skill in the arts will recognize that the systems and methods described herein can be used for the benefit of purchasers as well. For example, the systems and methods described herein can be used by a purchaser, who can automate when the system should buy tickets and automatically buy them. In addition, the systems and methods described herein can monitor multiple exchanges and incorporate an arbitrage between markets in which if comparable seats are selling at a lower price on one exchange and a higher price on another exchange, the system can automatically purchase those tickets and list them on the higher exchange.

Similarly, using the systems and methods described herein, sellers such as teams and concert promoters can price tickets on both the primary and secondary markets. By incorporating the auto-pricer and the forecasting model (which includes all the data currently available in the broker-dash application as well as non-economic and social data) sellers can create dynamic price rules that automatically change based on factors like demand (i.e. social “buzz”), total remaining inventory, type of remaining inventory (e.g., 2-packs have a different value than 3-packs), total “primary” market tickets versus “secondary” market tickets, rate at which tickets are selling, past sales data, and other data points. In some embodiments, the systems and methods described herein can be used by a ticket issuer (e.g., a primary market exchange which releases inventory) to provide the ability to automatically issue tickets (i.e. release inventory) at different times and in different quantities based on data in the forecast model etc. The issuer's POS system can include all facets of ticketing for a team and can also include data analytics to help stabilize and control the market. In addition, the data analytics (including social analytics) can help artists and teams determine the correct market price for a particular event or group of events.

In some embodiments, the systems and methods described herein can further include a Group-Auto-Pricer application. The Group-Auto-Pricer application configures the system to select a lowest ranked ticket (least valuable, e.g., based on face value of the ticket) in the user's inventory and set it using the Auto-Pricer application. Next, the system can select any additional listing for the same event to be part of a group based on predefined criteria. The system can then be configured to rank the tickets from worst to best (e.g., five, four, three, two, one), and set incremental pricing for each (e.g., $10, $1, etc.). Once the tickets are listed, the group of ticket listings can be auto-priced to move up or down following the lowest ranked listing as the basis. alternatively, the user can select to have tickets listed at different percentages above or below higher or lower ranked tickets (e.g., listing four is 5% higher than listing five and listing one is 30% higher than listing two, etc.).

In some embodiments, using the season pricer application, a user can apply the auto-pricer and/or group-auto-pricer to multiple games. Additionally, a user can select which games are “premium” games and auto-price those games at a higher range, and lower interest games at a lower range. Each group can have different price floors/ceilings and other rules, etc., based on user-preferences. In some embodiments, the rules can be set up once by the user and applied to multiple games throughout the season. Furthermore, user settings can be auto-saved and applied to other events and/or tickets at a later time.

At this juncture, it should be noted that although much of the foregoing description has been directed to providing forecasting and management systems and methods concerning ticket transactions in multiple markets, the systems and methods disclosed herein can be similarly deployed and/or implemented in scenarios, situations, and settings far beyond the referenced scenarios. It is to be understood that like numerals in the drawings represent like elements through the several figures, and that not all components and/or steps described and illustrated with reference to the figures are required for all embodiments or arrangements.

Thus, illustrative embodiments and arrangements of the present systems and methods provide a computer implemented method, computer system, and computer program product for managing ticket transactions in multiple markets. The flowchart and block diagrams in the figures illustrate the architecture, functionality, and operation of possible implementations of systems, methods and computer program products according to various embodiments and arrangements. In this regard, each block in the flowchart or block diagrams can represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The functions describe herein can be implemented by hardware and or hardware executing code (also known as programs, software, or software applications) which include machine instructions for a programmable processor, and can be implemented in a high-level procedural and/or object-oriented programming language, and/or in assembly/machine language. As used herein, the terms machine-readable storage medium and computer-readable storage medium refer to any computer program product, apparatus and/or device (e.g., magnetic discs, optical disks, memory, Programmable Logic Devices (PLDs)) used to provide machine instructions and/or data to a programmable processor, including a machine-readable storage medium that receives machine instructions as a machine-readable signal. The term machine-readable signal refers to any signal used to provide machine instructions and/or data to a programmable processor. A machine-readable storage medium does not include a machine-readable signal.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet. A wireless network can include both wired and wireless connections.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

It should be noted that use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Particular embodiments of the subject matter described in this specification have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A method of managing ticket inventory on one or more ticket exchanges performed by a server having memory, a processor, and one or more code sets stored in the memory and executable in the processor, the method comprising:
receiving, by the processor, a selection of first listing data relating to a first set of one or more tickets in a user's ticket inventory;
identifying, by the processor, based on the first listing data and one or more predefined user preferences, a set of available ticket listings listed on a first ticket exchange representing a first relative market with which to compare the first listing data;
determining, by the processor, a current market price for the first relative market;
determining, by the processor, a future market price for the first relative market;
assessing, by the processor, whether the future market price exceeds the current market price; and
setting, by the processor, a first listing price for the first set of one or more tickets on the first ticket exchange based on the assessing step.

2. The method as in claim 1, wherein the setting step further comprises:
setting the first listing price above the current market price when the future market price exceeds the current market price; and
setting the first listing price at or below the current market price when the future market price does not exceed the current market price.

3. The method as in claim 2, further comprising setting the first listing price equal to the future market price when the future market price exceeds the current market price.

4. The method as in claim 1, further comprising:
setting the first listing price relative to a first reference price when the future market price does not exceed the current market price;
monitoring the first reference price for any change in the first reference price; and
dynamically adjusting the first listing price as required to remain priced relative to the first reference price provided dynamically adjusting the first listing price would not cause the first listing price to be set outside a predetermined range.

5. The method as in claim 4, wherein the first reference price is one of the current market price and one of the set of available ticket listings representing the first relative market.

6. The method as in claim 4, wherein setting the first listing price relative to the first reference price further comprises setting the first listing price with a predetermined price differential relative to the reference price, the price differential being one of a dollar amount and percentage amount.

7. The method as in claim 4, further comprising sending an alert when dynamically adjusting the first listing price would cause the first listing price to be set outside the predetermined range.

8. The method as in claim 4, further comprising setting the first listing price relative to a second reference price when dynamically adjusting the first listing price would cause the first listing price to be set outside a predetermined range, wherein the second reference price is higher than the first reference price.

9. The method as in claim 1, further comprising:
setting a second listing price for the first set of one or more tickets on a second ticket exchange of the one or more ticket exchanges based on a second relative market of the second ticket exchange;
monitoring the first ticket exchange and the second ticket exchange for a purchase of the first set of one or more tickets; and
removing the first set of one or more tickets from the second ticket exchange when the first set of one or more tickets are purchased on the first ticket exchange.

10. The method as in claim 1, further comprising:
receiving, by the processor, a selection of second listing data relating to a second set of one or more tickets in a user's ticket inventory;
setting a second listing price for the second set of one or more tickets on the first ticket exchange relative to the first listing price of the first set of one or more tickets; and
dynamically adjusting the second listing price as required to remain priced relative to the first listing price.

11. The method as in claim 10, wherein setting the second listing price relative to the first listing price further comprises setting the first listing price with a predetermined price differential relative to the reference price, the price differential being one of a dollar amount and percentage amount.

12. A system in support of managing ticket inventory on one or more ticket exchanges comprising:
a server having a processor and memory;
a plurality of code sets stored in the memory and executable in the processor which, when executed, configure the processor to:
receive a selection of first listing data relating to a first set of one or more tickets in a user's ticket inventory;
identify, based on the first listing data and one or more predefined user preferences, a set of available ticket listings listed on a first ticket exchange representing a first relative market with which to compare the first listing data;
determine a current market price for the first relative market;
determine a future market price for the first relative market;
assess whether the future market price exceeds the current market price; and
set a first listing price for the first set of one or more tickets on the first ticket exchange based on the assessing step.

13. The system as in claim 12, further configured to:
set the first listing price above the current market price when the future market price exceeds the current market price; and
set the first listing price at or below the current market price when the future market price does not exceed the current market price.

14. The system as in claim 13, further configured to set the first listing price equal to the future market price when the future market price exceeds the current market price.

15. The system as in claim 12, further configured to:
set the first listing price relative to a first reference price when the future market price does not exceed the current market price;
monitor the first reference price for any change in the first reference price; and
dynamically adjust the first listing price as required to remain priced relative to the first reference price provided dynamically adjusting the first listing price would not cause the first listing price to be set outside a predetermined range.

16. The system as in claim 15, wherein the first reference price is one of the current market price and one of the set of available ticket listings representing the first relative market.

17. The system as in claim 15, wherein setting the first listing price relative to the first reference price further comprises setting the first listing price with a predetermined price differential relative to the reference price, the price differential being one of a dollar amount and percentage amount.

18. The system as in claim 15, further configured to send an alert when dynamically adjusting the first listing price would cause the first listing price to be set outside the predetermined range.

19. The system as in claim 15, further configured to set the first listing price relative to a second reference price when dynamically adjusting the first listing price would cause the first listing price to be set outside a predetermined range, wherein the second reference price is higher than the first reference price.

20. The system as in claim 12, further configured to:
set a second listing price for the first set of one or more tickets on a second ticket exchange of the one or more ticket exchanges based on a second relative market of the second ticket exchange;
monitor the first ticket exchange and the second ticket exchange for a purchase of the first set of one or more tickets; and
remove the first set of one or more tickets from the second ticket exchange when the first set of one or more tickets are purchased on the first ticket exchange.

21. The system as in claim 12, further configured to:
receive a selection of second listing data relating to a second set of one or more tickets in a user's ticket inventory;
set a second listing price for the second set of one or more tickets on the first ticket exchange relative to the first listing price of the first set of one or more tickets; and
dynamically adjust the second listing price as required to remain priced relative to the first listing price.

22. The system as in claim 21, further configured to set the first listing price with a predetermined price differential relative to the reference price, the price differential being one of a dollar amount and percentage amount.
